(19) United States
(12) Patent Application Publication
(10) Pub. No.: US 2016/0044862 A1
(43) Pub. Date: Feb. 18, 2016

(54) SITE SPECIFIC PRODUCT APPLICATION DEVICE AND METHOD

(71) Applicant: Raven Industries, Inc., Sioux Falls, SD (US)

(72) Inventor: Jared Ernest Kocer, Sioux Falls, SD (US)

(21) Appl. No.: 14/826,953

(22) Filed: Aug. 14, 2015

Related U.S. Application Data
(60) Provisional application No. 62/037,442, filed on Aug. 14, 2014.

(51) Int. Cl. A01C 23/00; A01M 7/00

(52) U.S. Cl. CPC A01C 23/007; A01M 7/0089; A01C 23/00

(57) ABSTRACT

The present disclosure relates to a site specific agricultural product delivery method, system, and apparatus. The apparatus includes a toolbar including at least one agricultural product delivery nozzle coupled to the toolbar, the agricultural product delivery nozzle configured to deliver an agricultural product to a plant. One or more sensors are coupled to the toolbar, the one of more sensors configured to detect a plant characteristic of the plant. A controller is configured to associate the plant with an agricultural product characteristic based on the plant characteristic, the controller configured to operate the delivery nozzle to deliver the agricultural product proximate to the plant.

### CLAIM OF PRIORITY

This patent application claims the benefit of priority to U.S. Provisional Application No. 62/037,442, filed Aug. 14, 2014, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak.; All Rights Reserved.

### TECHNICAL FIELD

This document pertains generally, but not by way of limitation, to product application devices and methods for delivery of an agricultural product to crops.

### BACKGROUND

Application of agricultural products including fertilizer, herbicides, pesticides and the like, to agricultural crops, such as corn, is an important process for increasing crop yield. In one example, a high clearance nitrogen toolbar is configured to generally deliver nitrogen (e.g., fertilizer) to an agricultural field. These high clearance nitrogen toolbars deliver nitrogen from an elevated height to plants (e.g., corn stalks) to prevent damage to the plant. In some examples, high clearance nitrogen toolbars deliver nitrogen in a constant stream to the roots of plants as well as the soil disposed between subsequent plants. That is, an operator controls an on/off nitrogen delivery switch that is operated at the beginning and end of fertilizing operations to open and close a nitrogen delivery valve to begin and end application of the fertilizer.

### Overview

The present inventor has recognized, among other things, that a problem to be solved can include the reduction of wasted fertilizer during a fertilization process. For instance, high clearance nitrogen toolbars include nitrogen delivery modes that provide nitrogen in an ongoing stream. That is, nitrogen is applied to plants (e.g., corn stalks) as well as the soil disposed between the plants. Such a delivery mode wastes nitrogen (and similarly wastes other agricultural products like herbicides, pesticides or the like). In an example, the present subject matter can provide a solution to this problem, such as by providing a site specific agricultural product delivery system including sensor on a leg of the high clearance agricultural product toolbar configured to detect a plant and trigger an agricultural product delivery nozzle to provide agricultural product to the corn plant. The site specific agricultural product delivery system conserves product by applying it to the specific location of the plant and not generally to the row of plants. In one example, the system includes a toolbar, a sensor, and an agricultural delivery product nozzle (e.g., fertilizer delivery nozzle). Accordingly, the system operates by detecting a plant location (e.g., a corn stalk location) and delivering the agricultural product to the location of the plant

The present inventor has recognized, among other things, that a problem to be solved can include specifying a desired amount of agricultural product to be delivered to a specific plant. For instance, current fertilizer delivery methods specify a rate of fertilizer delivery which is applied to each row. In an example, the present subject matter can provide a solution to this problem, such as by providing a system and method to sense a fertilization characteristic of a plant and determine an amount of fertilizer to be delivered to the plant (e.g., in real time). The system and method, in an example, include an optical sensor positioned ahead of the agricultural product deliver nozzle. The sensor senses the agricultural product characteristic of the plant (e.g., by moisture detection, normalized difference vegetation index, density readings). In an example, agricultural product concentration, agricultural product type, agricultural product amount, or a combination therein is controlled (e.g., by a controller) based on the sensed agricultural product characteristic.

Use of the system provides for only greater concentration of agricultural product applied to the stalk, but also far less necessary agricultural product per acre. This results in both cost savings and environmental benefits.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present description.

FIG. 1A provides a front view of an agricultural product delivery apparatus.

FIG. 1B provides a top view of the agricultural product delivery apparatus illustrated in FIG. 1A.

FIG. 2 provides is a top view of one example of an agricultural product delivery apparatus and an agricultural field.

FIG. 3 provides a flow chart of a method for delivering an agricultural product.

FIG. 4 provides a variable rate map illustrating characteristics of a field according to a given area of the field.

FIG. 5 provides an exemplary schematic view of an overall nozzle control system.

FIG. 6 provides a detailed schematic view of an exemplary nozzle control system.

FIG. 7 provides an exemplary schematic view of a nozzle ECU.

FIG. 8 provides an alternative exemplary schematic view of a nozzle ECU.

FIG. 9 provides a block diagram showing one example of a method for controlling nozzle flow rate on an agricultural sprayer.

FIG. 10 provides a close-up view of a smart nozzle for use in a nozzle control system.

### DETAILED DESCRIPTION

As noted above, to date, previously practiced methods of applying agricultural product to a field, and apparatuses for delivering such agricultural product have created inefficient use and waste of the agricultural product in question. The presently described apparatuses and methods provide for an improvement over known methods in the art that allow for detection of plants (e.g. corn stalks) and delivery of agricultural product directly to the site of the stalks.

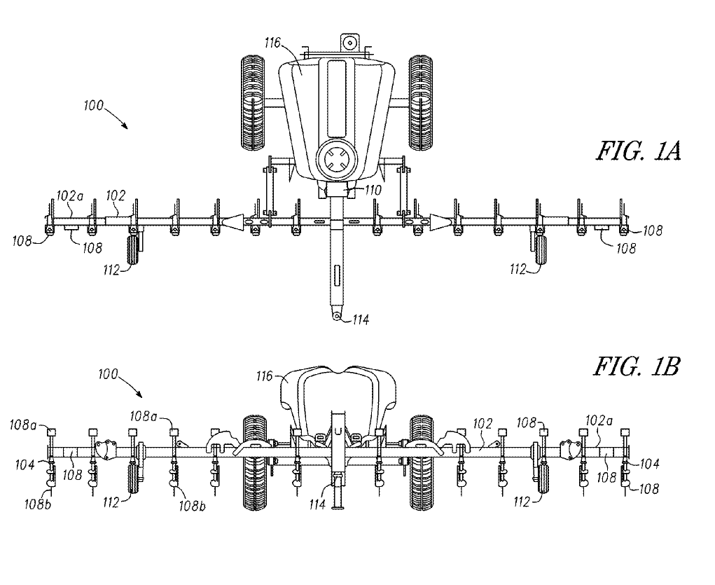

FIGS. 1A, B illustrate an agricultural product delivery system (e.g., apparatus 100) according to the present description. In one example, the apparatus 100 includes a toolbar 102. In some examples, the tool bar is a push-type toolbar (positioned in front of a tractor or other vehicle and pushed by the vehicle), and in other examples, the toolbar is a pull-type toolbar (positioned behind or in the back of a tractor or other vehicle and pulled by the vehicle). FIGS. 1A and 1B provide front and top views respectively of a pull-type toolbar that is pulled behind a vehicle. The toolbar 102 includes, in an example, a plurality of legs 104, with one or more legs extending from the toolbar. In the example, the agricultural product delivery apparatus 100 further includes at least one agricultural product delivery nozzle 106 that is coupled to at least one of the plurality of legs 104. One or more nozzles 106, and in one example, each of the one or more nozzles 106, are coupled with a respective leg of the plurality of legs 104. Agricultural product delivery nozzle 106 is also illustrated in FIGS. 1A and 1B. The agricultural product delivery nozzle 106 delivers an agricultural product proximate to a plant, such as a corn stalk. In some examples, agricultural product delivery nozzles 106 are “smart” nozzles that are coupled with or incorporate electronic control units (ECUs), as further described below. As further shown, wheels 112 are optionally positioned at the bottom of at least some of the legs 104 to facilitate forward movement of the system and consistent leveling of the tool bar 102 and the nozzles 106 relative to the ground when pushed or pulled by a vehicle 103.

In an example, agricultural product delivery apparatus 100 also includes one or more sensors 108 that is coupled to the toolbar 102. In another example, the sensor 108 is coupled directly to the laterally extending portion of the tool bar (e.g. the portion illustrated as 102a). Though shown in FIGS. 1A and 1B as being positioned proximate the edge of the tool bar, the sensors 108 can be directly coupled to the laterally extending portion of the tool bar at any number of points along the tool bar, including points proximate the center of the toolbar. In still another example, one or more sensors 108 are coupled to respective legs of the plurality of legs 104 that in part make up the toolbar. The sensor 108 detects a plant characteristic, such as a corn stalk characteristic (e.g., corn stalk location, a type of corn, dimensions of the corn stalk, and a normalized difference vegetation index factor—discussed further herein). In an example, the sensor 108 detects the plant characteristic while the plant is ahead of the agricultural product delivery nozzle (i.e., the nozzle and the apparatus 100 are approaching the plant). In some examples, as illustrated in FIG. 1A, the agricultural product delivery apparatus 100 includes a first sensor 108a (e.g., an “upper” sensor) and a second sensor 108b (e.g., a “lower sensor”) positioned on or near a common leg 104. Alternatively, one or both of the upper sensors 108a and 108b is positioned on the toolbar 102. In these examples the first and second sensors 108a, are the same or different types of sensors (e.g., contact-type sensors, and/or non-contact type sensors as described in greater detail herein). The Agricultural product is, in some examples, stored in reservoir tank 116, and may be integrally formed with the agricultural product delivery apparatus or may, for example, be towed separately from the agricultural product delivery apparatus. In either case, the reservoir tank 116 will be fluidly coupled with nozzles 106.

The agricultural product delivery apparatus 100 also includes, in one example, a controller 110. The controller 110 associates the plant (e.g., a measured corn stalk) with an agricultural product characteristic based on the plant characteristic. In various examples, the agricultural product characteristic includes at least one of a type of agricultural product (e.g., fertilizer, herbicide, pesticide, water or the like), a concentration of agricultural product, a delivery rate of agricultural product, a delivery time of agricultural product, an amount of agricultural product, and the like. The controller is, in one example, further configured to operate the delivery nozzle 108 to deliver the agricultural product proximate to the plant (e.g., a corn stalk). In one example, the plant in question (i.e., the corn stalk measured with the sensor 108) is positioned at a known distance away from the agricultural product delivery nozzle when the nozzle is opened in order to dispense the agricultural product. This distance at which dispensation is activated is determined and measured by sensors 108.

Referring again to FIGS. 1A, B, the sensor 108 includes, in certain examples, any number of sensor constructions including, but not limited to, a contact type sensor, such as a whisker sensor, a load cell, a force impact sensor, a pressure sensor, and the like. In another example, the sensor 108 includes, but is not limited to, a non-contact type sensor, such as an optical sensor, a video sensor network, a single stream video, an infrared sensor, and the like. In some examples, as described herein, more than one sensor type is included in the agricultural product delivery apparatus 100. For example, in one arrangement the apparatus 100 includes both one or more contact type sensors and one or more non-contact type sensors. Where a contact-type sensor is used, the contact-type sensor is optionally positioned in the position of the second sensors 108b to ensure that it is most likely to contact plants (e.g., stalks of corn plants). Accordingly, in an example the second sensors 108b are a contact-type sensor and the first sensors 108a are a non-contact type sensor, such as an optical sensor.

In yet another example, at least one sensor 108 is a normalized difference vegetation index (NDVI sensor). An NDVI sensor measures the “greenness” of a plant and the output characteristic is used to measure an amount of fertilizer for the plant (e.g., a corn plant). Live green plants absorb solar radiation in the photosynthetically active radiation (PAR) spectral region. Plants use radiation from this region as a source of energy in the process of photosynthesis. Leaf cells have also evolved to scatter solar radiation in the near-infrared spectral region (which carries approximately half of the total incoming solar energy), because the energy level per photon in that domain (wavelengths longer than about 700 nanometers) is not sufficient to be useful to synthesize organic molecules. A strong absorption at these wavelengths would only result in overheating the plant and possibly damaging the tissues. Hence, live green plants appear relatively dark in the PAR and relatively bright in the near-infrared. The pigment in plant leaves, chlorophyll, strongly absorbs visible light (from 0.4 to 0.7 μm) for use in photosynthesis. The cell structure of the leaves, on the other hand, strongly reflects near-infrared light (from 0.7 to 1.1 μm). Thus, the measurements from the NDVI sensor (e.g., of PAR and near-infrared brightnesses) reflect overall health or “greenness” of the plant. This measurement is correlated to an amount of agricultural product (such as fertilizer) for delivery to the plant (e.g., a corn stalk), for instance by the controller 100.

Where an NDVI sensor (or sensors) is used, the NDVI measurements from the sensor are, in an example, frequently updated (e.g., continuously, near continuously, intermittently or the like) as the vehicle moves through a field. FIG. 2 illustrates this function. For example, as vehicle 103 moves through the field, the NDVI sensor will, in one example, take a measurement of a region 220 located in front of the sensor 108. The NDVI measurement is updated as the region, and therefore crop characteristics, change with forward progression of the vehicle 103. For instance, as the vehicle 103 moves forward to the point that sub-region 220a is added to the region 220, the measurements from sub-region 218 as a portion of the NDVI measurement of the region are dropped and NDVI measurement is re-measured for (updated) region 220 including added region 220a. As the vehicle continues moving, for instance forward, the measurement of sub-region 222 is incorporated in the NDVI agricultural crop measurement (and corresponding nozzle spray characteristics) while sub-region 220b is removed from the measurement. The updating of NDVI measurements provides for more optimal agricultural product spray characteristics for a given region as the vehicle moves through the field.

FIG. 2 further illustrates the position of plants, such as corn stalks 224 relative to vehicle 103 and agricultural product apparatus 100 including the toolbar 102. The apparatus 100 including the agricultural product delivery nozzles 106 coupled to toolbar 102 dispense the agricultural product directly on or proximate to corn stalks 224. In at least one example, the apparatus 100 avoids dispensing agricultural product in regions 226 between corn stalks 224.

In one embodiment, the one or more sensors 108 (including 108a, b) detect the location of the plant, such as a corn stalk, at a distance from the respective fertilizer delivery nozzle 106. For example, a contact type sensor 108 is positioned to contact the plant 6 inches ahead of the delivery nozzle 106. In another example, an optical sensor 108 detects the location of the plant a specified distance ahead of the oncoming delivery nozzle 106 (e.g., 6 inches ahead of the delivery nozzle). The distance of the plant from the sensor 108 and known speed of the vehicle (nozzle relative to the stalk) is used to determine a time delay for delivery of the agricultural product from the delivery nozzle 106 to the plant (corn or plant stalk, base of the corn or plant stalk, leaves or the like). For example, the speed of the vehicle 103, determined by a speed sensor (e.g., GPS, axle rotation sensor or the like), is used to determine the time it takes for the vehicle (e.g., the nozzle 106) to travel the known distance (e.g., measured with the sensor 108 or known based on the plant entering the edge of the operating range of the sensor 108) between the detected plant location and the delivery nozzle. The determined time is the time delay, and after the determined time delay the delivery nozzle 106 delivers the agricultural product to the plant (e.g., proximate the stalk, leaves, base of the stalk or the like). Proximate includes about 2 inches from the plant, about 1 inch from the plant, and at the plant.

In another sense, the present description provides for an agricultural product delivery system. Such a system includes the agricultural product delivery apparatus 100 described herein including, but not limited to, a toolbar 102 (in this case a toolbar that includes a crossbar with a plurality of legs extending therefrom), at least one agricultural product delivery nozzles 106 coupled to one of the plurality of legs 104, one or more sensors 108, and a controller 110. The controller 110 associates a detected plant (e.g., a corn stalk) with an agricultural product characteristic based on a characteristics of the plant (e.g., a plant characteristic or corn stalk characteristic, such as NDVI). The system further includes a vehicle 103 configured to move the remainder of the apparatus 100. The vehicle 103 and apparatus 100 are coupled together by coupling the high clearance toolbar to the vehicle.

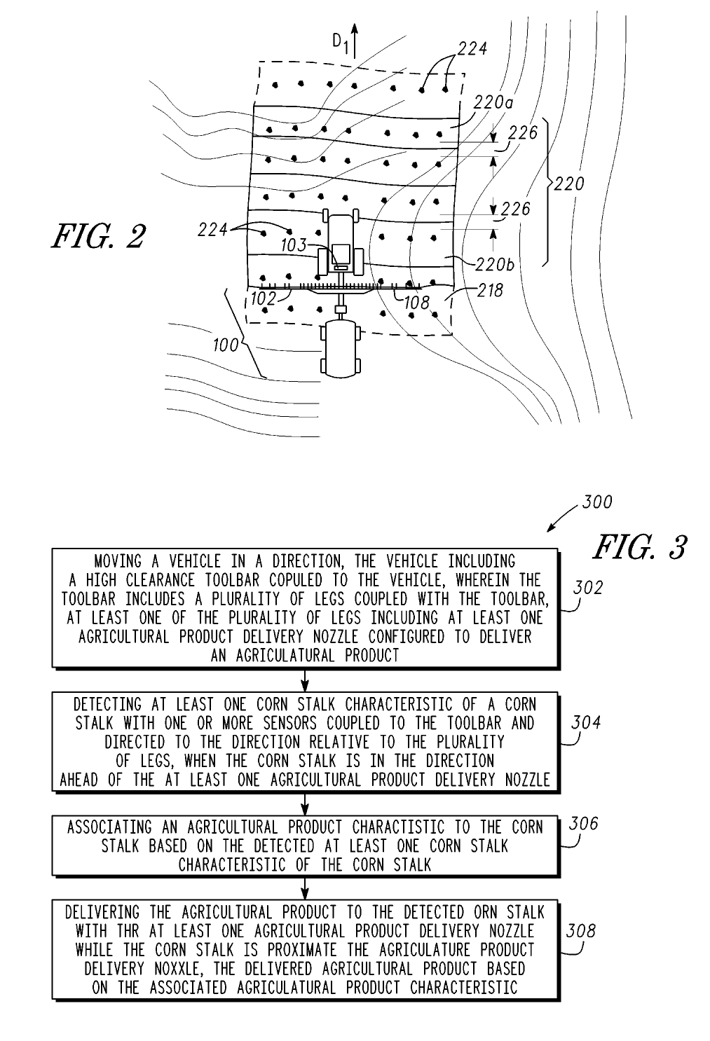

In another example, the present description provides a method 300 for delivering an agricultural product. Such a method is illustrated in FIG. 3. The method includes step 302 of moving a vehicle in a direction. In various examples, the vehicle may move in a forward direction, backward direction, sideways direction, and the like. In one example, the vehicle 103 includes a high clearance toolbar 102 coupled to the vehicle 103 and includes a plurality of legs 104 coupled with the toolbar 102. At least one of the plurality of legs 104 includes at least one agricultural product delivery nozzle 106 that delivers an agricultural product. In one example, the delivery nozzle 106 is coupled to an agricultural product storage tank 116 by one or more pipe, tube, or conduit. The method 300, in an example, includes the additional step 304 of detecting at least one plant characteristic of a plant with one or more sensors 108 coupled to the toolbar 102 and directed in the direction relative to the plurality of legs 104. The plant is positioned such that it is in the direction ahead of the at least one agricultural product delivery nozzle 106. In an example, the method additionally includes the step 306 of associating an agricultural product characteristic to the plant based on the detected at least one plant characteristic (e.g., corn stalk characteristic) of the plant (e.g., a corn stalk). Further, in an example, the method includes the step 308 of delivering the agricultural product to the detected plant with the at least one agricultural product delivery nozzle 106 while the plant is proximate the agricultural product delivery nozzle 106. The delivered agricultural product is based on and optionally delivered in a manner based on the associated agricultural product characteristic.

Detecting the at least one plant characteristic (e.g., in the case of a corn stalk-corn stalk location, a type of corn, dimensions of the corn stalk, a normalized difference vegetation index factor, or the like) is accomplished with at least one sensor 108 as described herein. For example, in one example, detecting is performed using a contact sensor 108. In the case of a contact sensor, the sensor 108 is positioned ahead of or in front of the delivery nozzle 106 and contacts the plant. Contact with the plant (e.g., a corn stalk) is registered by the controller 110 and is indicative of a detected plant. The controller measures the distance from the plant to the sensor 108 or associates a known distance from where the sensor 108 contacts the plant to the delivery nozzle 106. In combination with the distance (known or measured) and speed of the vehicle 103 the controller 110 operates the agricultural delivery nozzle 106 to deliver the agricultural product to the plant as the nozzle becomes proximate to the plant. In another example, detecting is performed using a non-contact sensor 108. In the case of a non-contact or optical sensor, the sensor 108 is positioned at one or more locations including ahead of the delivery nozzle 106, substantially at the same location as the delivery nozzle 106, or behind the delivery nozzle 106. The non-contact sensor 108 detects the oncoming plant location from any of these position prior to the plant being proximate to the nozzle 106.

The agricultural product characteristic described in the method 300 includes, but is not limited to, at least one of a type of agricultural product (e.g., fertilizer, herbicide, pesticide, water or the like), a concentration of agricultural product, a delivery rate of agricultural product, a delivery time of agricultural product, a quantity of agricultural product, and the like. In one given example (though not shown in the figure), the method includes an additional step of determining the delivery time (e.g., a time delay between detection of the plant and movement of the nozzle 106 to a location proximate to the plant) of agricultural product based on at least one of distance of the one or more sensors 108 relative to the toolbar and a speed of the vehicle in the direction the vehicle is moving.

The agricultural product delivered by the nozzles include, but are not limited to, fertilizers, herbicides, pesticides, water or the like. Where the agricultural product in question in a fertilizer, the fertilizer can include any common fertilizer used in the agricultural industry, including but not limited to nitrogen and ammonia and a carrier fluid (e.g., water) carrying a varied concentration of the agricultural product controlled with the method 300 and apparatus 100 described herein.

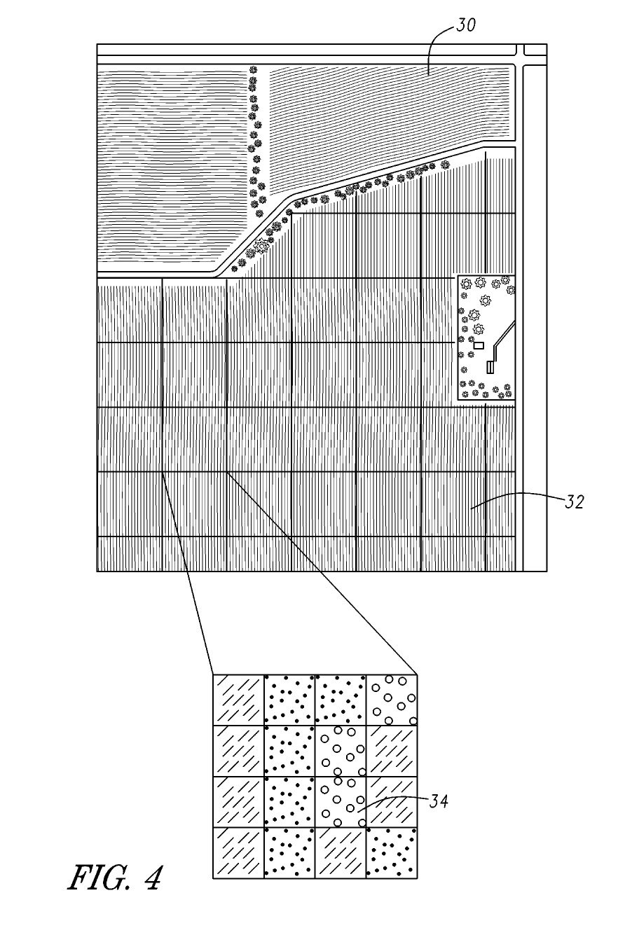

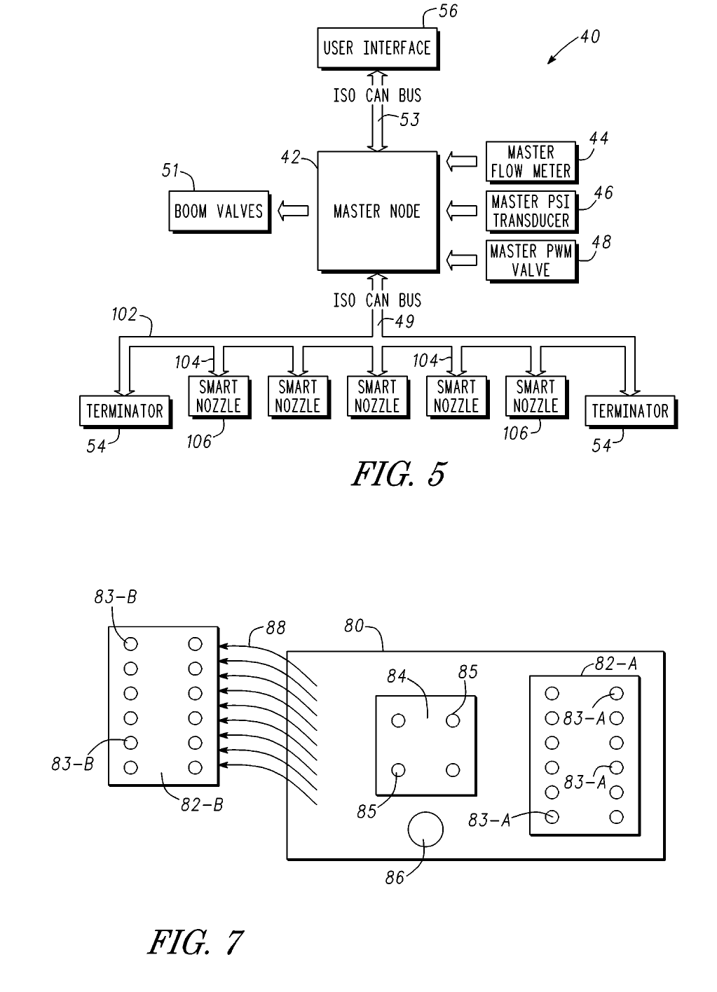

In an example, the system, apparatus, and method control one or more of the type of fertilizer delivered, amount of fertilizer delivered, concentration of fertilized delivered, or a rate of fertilizer to be delivered. These determinations can be made or aided through use of a variable rate map that corresponds to a field, such as the map illustrated in FIG. 4. For example, the variable rate map, indicating relative crop growth, is used to correlate a desired amount of fertilizer to be delivered to the corn within a specified region. In such an example, GPS is used to locate the vehicle, sensor, or delivery nozzle.

Optionally the variable rate map 30 includes but is not limited to providing a visual representation of agricultural product delivery instructions, such as, but not limited to, a soil characteristic, crop yield, agricultural product instructions, or any combination thereof. A zoomed in portion of the variable rate map 30 is shown in the bottom view of FIG. 4. As shown by way of varying stippling, shading, or the like a plurality of zones 32 accordingly has corresponding agricultural product delivery instructions (e.g., agricultural product type or flow rate, etc.), magnitude of the comparison, or type of calibration instruction. For instance, as shown in FIG. 4, a plurality of zones 32 having a varying agricultural product delivery instructions are associated with the one or more zones 32. Accordingly each of the zones 32 includes in one example an array of information including the agricultural product delivery instructions. The variable rate map 30 optionally provides a representation to the operator of the agricultural product delivery demands during an agricultural product delivery operation. Alternatively, a controller, in an example, processes the information from the variable rate map to automatically change or control the agricultural product delivery characteristics. Information provided by the variable rate map 30 is optionally used for instance to determine better husbandry techniques, planting strategies and the like for the field in the next season.

Referring again to FIG. 4, the plurality of zones 32 include sub-zones 34. As shown, each of the zones and sub-zones has different stippling, shading or the like associated with harvested crop characteristics. Optionally the sub-zones 34 (or any of the plurality of zones 32) have varying stippling, shading or coloring techniques or any combination thereof to accordingly provide indications of calibration instructions, magnitude of comparisons, or both. As shown in FIG. 4, by way of the stippling, shading, coloring or the like the agricultural product delivery instructions vary between each of the zones 32. As shown for instance, each of the sub-zones 34 the stippling is different between the zones thereby indicating agricultural product delivery instructions, such as agricultural product type, there between varies. Optionally the variable rate map 30 provides one or more interactive zones 32. For instance the user is able to zoom in and examine each of the zones 32 accordingly allowing for instance through a graphical user interface interaction with the variable rate map 30 to accordingly determine the agricultural product delivery instructions of one or a plurality of the zones 32.

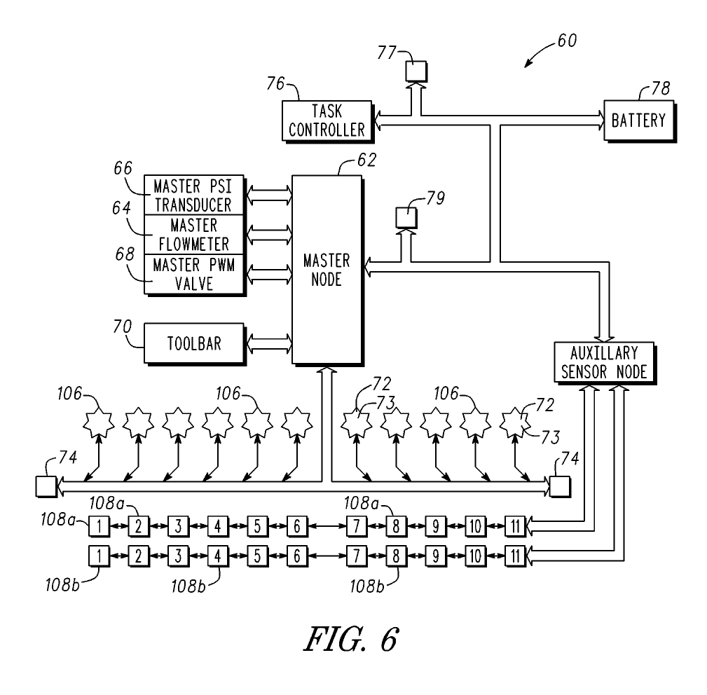

In some examples, the agricultural product delivery apparatus 100 uses an overall nozzle control system 40. Such a system can include so-called “smart nozzles” as described in further detail herein. FIG. 5 illustrates a schematic of an exemplary overall nozzle control system 40, wherein electronic control units associated with one or more nozzles 106 on a toolbar 102 (and coupled via legs 104) are capable of controlling a respective nozzle flow rate of an agricultural product dispensed from the nozzle 106. This particular figure is a simplified version of the system. The sensors previously described herein (e.g., sensors 108, first sensors 108a and second sensors 108b) communicate with the system 40. One example of a control system 60 with smart nozzles 106 (nozzles (to dispense the agricultural product) and an electronic control unit (ECU)) and sensors 108 is provided in detail in FIG. 6, described below.

Returning to FIG. 5, the example system 40 includes a master node 42 communicatively coupled to one or more valves 51 (e.g., boom valves) of the toolbar 102, such that system pressure within the toolbar 102 is optionally controlled by the master node 42. Optionally, the master node 42 of the system 40 is not configured to control the flow rate within the system 40, toolbar 102, or at the smart nozzles 106. The master node 42 includes inputs from a master flowmeter 44, a master pressure transducer 46, and a master pulse width modulation (PWM) valve 48. The master node 42 controls the master PWM valve 48 to maintain the targeted system pressure, for instance so a desired droplet size of the agricultural product is obtained from the nozzles 106. In one example, environmental conditions, such as wind, humidity, rain, temperature, field characteristics, or user preference determine whether a smaller or larger droplet size of the agricultural product is preferred (e.g., larger droplets are less prone to disturbance by wind while smaller droplets are better atomized and spread around a target plant). By maintaining a constant system pressure, the preferred droplet size is maintained at the nozzles 106 for the system 40.

Looking to FIG. 6, in an exemplary embodiment, each of the nozzles 106 is a smart nozzle that includes a nozzle (to dispense the agricultural product) and an electronic control unit (ECU). The ECU controls (e.g., regulates, changes, maintains or adjusts) the nozzle flow rate of the agricultural product dispensed from the nozzle 106 by controlling operation of the nozzle (see FIG. 6). In other embodiments, a group of nozzles 106 are associated with a common ECU and as a group are considered a single smart nozzle. For example, the nozzles 106 are connected to a toolbar 102 (e.g., along one or more legs 104) and communicatively coupled to a controller area network 49 (e.g., ISO CAN bus) of the overall control system 40. The control system 40 includes the master node 42 that optionally serves as the common ECU and is connected to the nozzles 106 by way of the controller area network 49. As discussed herein, the CAN bus 49 is configured to provide overall system information from the master node 42 (e.g., master node) to the nozzles 106 (e.g., as control signals). In another example, ECUs at each smart nozzle 106 receive data (and optionally transmit data) from the overall system 40 (including the master node 42) to control operation of the nozzle components of the smart nozzles 106 (e.g., to regulate, maintain, change, or adjust the nozzle flow rate of each corresponding smart nozzles 106).

Referring again to FIG. 5, in one example the master node 42 controls a system pressure with a master PSI transducer 46 and the master pulse width modulation (PWM) valve 48, instead of controlling a system flow rate. Although FIG. 5 illustrates a PWM valve as the master valve 48, embodiments are not so limited. For example, the master valve 48 includes any valve capable of controlling pressure of a system, such as, for example, a ball valve, a PWM valve, or a butterfly valve. In another example, the master node 42 maintains the system pressure at a target system value in contrast to affirmatively controlling the agricultural product flow rate, and the flow rate is instead controlled at each smart nozzle 106 (e.g., by the master node, ECUs at each smart nozzle 106 or a combination of the master node and ECUs). In another example, the master node 42 controls the system pressure to one or more target values and the smart nozzles 106 control the flow rate at each of the smart nozzles 106 and, therefore, the overall agricultural product flow rate of the system.

In an example, the target system pressure is provided by a user, such as at the User Interface 56 (UI) connected to the master node 42 by the ISO CAN bus 53. In an additional example, the user also provides a target system flow rate (e.g., volume/area) at the UI. In an example, the master node 42 provides the target system flow rate to each of the one or more smart nozzles 106, such that each smart nozzle 106 (or each ECU, as discussed herein) determines an individual agricultural product flow rate for the smart nozzle 106. For example, the system target flow rate is divided by the number of nozzles to provide a target agricultural product flow rate for each of the one or more nozzles 106. In an example, the master node measures the flow rate (e.g., volume per time) with a master flow meter 44 and compares it with the overall target flow rate (e.g., designated by one or more of the user, crop type, soil characteristic, agricultural product type, historical data, or the like). The master node 42 is configured to determine a difference or error, if present, between the measured system flow rate and the target system flow rate. In such an example, the master node 42 provides the determined difference, by the ISO CAN bus 53, to the individual nozzles 106 (or ECUs, as discussed herein). The one or more nozzles 106 receive the difference on the CAN bus 53 and adjust their pressure/flow/duty cycle curve using the difference (e.g., compensating for errors in the system) to reduce the error between the measured and target system flow rates.

In one example, the nozzle 106 with set flow rate is operated (turned on) according to the identification of a plant with sensors 108 and the determination of determined time delay until spray based upon the speed of the vehicle 103. In another example, the smart nozzle 106 receives plant characteristics, such as NDVI, from the sensors 108 (e.g., 108b) and the flow rate of the agricultural product is tuned according to the measured plant characteristic. For instance, with a low NDVI (low greenness) reading, the component flow rate of the nozzle 106 (e.g. a component part of the target system flow rate or measured system flow rate) is adjusted upwardly by the smart nozzle EDU to dispense a larger quantity of agricultural product. Conversely, if high NDVI (high greenness) is measured, the component flow rate is adjusted downwardly to conserve the product. In other examples, one or more characteristics are adjusted at the nozzles, including flow rate, time of application, concentration (e.g. by way of a controlled product injector at the nozzle) or the like.

Additionally, in at least some examples, the master node 42 reports the actual pressure, measured by the master PSI transducer 46, as well as toolbar 102 information, including, but not limited to, one or more of yaw rate, speed, number of smart nozzles of the toolbar, distance between smart nozzles on the toolbar 102, to the smart nozzles 106 (or ECUs, as described herein) for individual flow rate control of each of the smart nozzles 106. For example, the information provided from the master node 42 is used in addition to nozzle characteristics to control the individual flow rate of each smart nozzle 106. Nozzle characteristics include, but are not limited to nozzle position on a toolbar, length of the toolbar, nozzle spacing, target flow rate for the system, yaw rate of the toolbar, yaw rate of the agricultural sprayer, speed of the agricultural sprayer, the overall system pressure, and agricultural product characteristics. The system 40 is configured to be installed on an agricultural sprayer, and as such, since the sprayer moves during operation (translates and rotates), the one or more nozzle characteristics, in an example, are dynamic and accordingly changes the individual flow rate.

FIG. 6 illustrates a detailed schematic view of an exemplary nozzle control system 60. The control system 60 includes a master node 62 communicatively coupled to one or more valves of the toolbar 70. As described herein, the system pressure is controlled by the master node 62, for instance through control of a pulse width modulation valve 68. Further, the master node 62 includes inputs from a master flowmeter 64, a master pressure transducer 66, and a master pulse width modulation (PWM) valve 68. Furthermore and as described herein, the master node 62 is optionally coupled to a UI 76 and, in an example, a battery 78, so as to provide power to one or more of the master node 62 and UI 76.

As shown in the embodiment of FIG. 6, each smart nozzle 106 includes an ECU 72 coupled to a PWM valve 73. From the center region of the toolbar, the ECUs 72 are communicatively coupled to the most proximate ECU 72 in the direction toward each terminal end 74 of the toolbar. That is, the ECU nearest the center of the toolbar is communicatively coupled to the next ECU towards the terminator, which is communicatively coupled to the next closest ECU to the terminator, and so forth until the terminator after ECU-1 is reached. The same pattern holds for the other half of the toolbar. Further, each ECU 72 is coupled to one PWM valve 73, however, embodiments are not so limited. For example, a single ECU 72 is communicatively coupled to more than one PWM valve 73. Said another way, a single ECU 72, in an example, is communicatively coupled to more than one nozzle, such as, for example, every other nozzle. In an example, a plurality of nozzles are partitioned into nozzle groups, such that each nozzle group includes an ECU 72 configured to control a nozzle group flow rate of the agricultural product dispensed from each nozzle of the nozzle group based on the nozzle characteristics, as described herein, of the respective nozzles. Benefits of such embodiments include reducing costs. Thus, a smart nozzle is a single nozzle and an associated ECU or is a group of nozzles associated with a common ECU.

The system of FIG. 6 additionally includes a plurality of sensors 108. Sensors 108 are positioned along the length of the toolbar and can be grouped into first sensors 108a and second sensors 108b. As discussed above, the first sensors 108a and second sensors 108b may be different sensor types. For example, first sensors 108a may be non-contact type sensors and second sensors 108b may be contact-type sensors (or a different type non-contact type sensors that sensors 108a). Alternatively, the group of first sensors 108a may include different sensor types and/or the group of second sensors 108b may include different sensor types.

Sensors 108 are connected to an Auxiliary Sensor Node 79 that connects the sensors 108 to the Master Node 62 as well as to the battery 78 and the UI 76. In one example, sensors 108 communicate information regarding the proximity of the stalks to the nozzles 106 to the Auxiliary Sensor Node 79. The Auxiliary Sensor Node 79 communicates this proximity data to the Master Node 62, which in turn communicates the information to the ECUs 72 associated with each of the nozzles 106. The ECU 72 can then instruct whether the sprayer of each of the respective nozzles 106 should be opened or closed, based on whether it is in close proximity to the stalk (in which case it should be open) or distant from the respective stalk (in which case it can be closed).

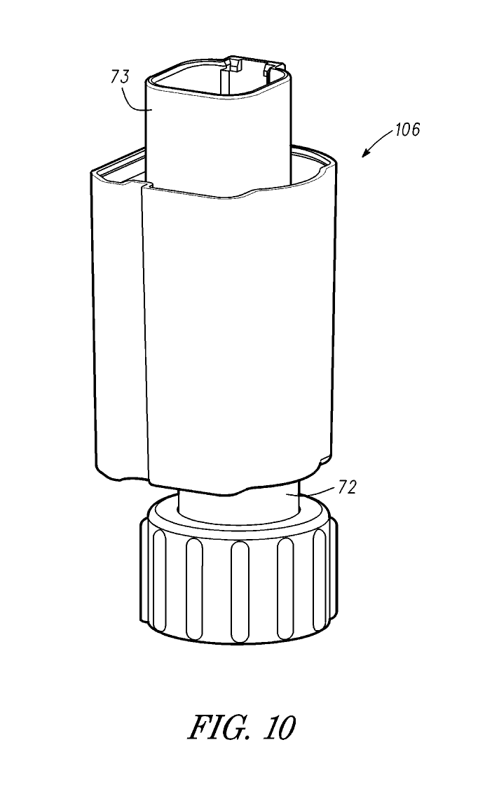

An exemplary smart nozzle 106 is shown in FIG. 10. The smart nozzle 106 includes both an ECU 72 and a PWM valve 73. The ECU 72 is in communication with the PWM valve 73 and accordingly operates the PWM valve to dispense the agricultural product as desired, for instance, according to measurements provided by the sensors 108 and conveyed by the master node 62. As described herein, the sensors 108 identify a plant (e.g., at an oncoming distance relative to the smart nozzle 106) and in one example a timed delay is determined based on the speed of the vehicle in combination with the distance of the plant relative to the nozzle 106. The ECU 72 of the smart nozzle 106 operates the PWM valve 73 at expiration of the delay time to accordingly dispense the agricultural product to the plant from the nozzle.

In another example, the ECU 72 cooperates with the PWM valve 73 to control the dispensing of the agricultural product including, but not limited to, flow rate of the agricultural product, controlling the volume of agricultural product dispensed, the length (time) of dispensing and the like. For instance, the ECU 72 of the smart nozzle 106 receives a plant characteristic, such as NDVI, from a sensor such as the sensor 108b via the master mode 62. The ECU 72 operates the PWM valve 73 to accordingly dispense agricultural product from the smart nozzle 106 based on the measured plant characteristic (e.g., plant location, a type of plant, dimensions of the plant, a normalized difference vegetation index factor, or the like). In an example where high NDVI (greenness) is measured for an identified plant, the ECU 72 controls (regulates, changes, maintains or adjusts) the PWM valve 73 to administer a decreased amount (flow rate) of the agricultural product, such as fertilizer when the smart nozzle 106 is in proximity to the plant. In another example, a lower NDVI is measured (e.g., by the sensor 108b) and the ECU 72 controls the PWM valve 73 to thereby administer more of the agricultural product through the nozzle 106, for instance at a higher flow rate, when the smart nozzle 106 is in close proximity to the plant. Precise application of a specified amount of agricultural product is thereby achieved on a plant by plant basis according to the needs of the individual plants. Additionally, agricultural product is conserved and dispensed as specified at the identified plants and not otherwise broadly dispensed to the field or along rows. In still another example, the system 60 includes one or more location fiducials associated with the system 60, the one or more location fiducials are configured to mark the location of one or more nozzles (or ECUs) of the plurality of nozzles on a field map (e.g., indexed with product flow rates, moisture content, crop type, agricultural product type, or the like). Optionally, each of the nozzles, nozzle groups, or ECUs 72 of the system is configured to control the agricultural product at individual rates according to the location of the one or more nozzles (or ECUs 72) of the plurality of nozzles on the field map (and optionally in addition to the nozzle characteristics described herein). Further, each of the plurality of nozzles (or ECUs 72) can be cycled, such as on/off, according to the nozzle's (or nozzle group's or ECU's 72) location on the field. This is in contrast to previous approaches which required all the nozzles of a section of the toolbar to be shut off or turned on at the same time.

In an example, each nozzle ECU 72 is programmable to receive, track, or manipulate designated nozzle control factors. For example, each ECU 72 focuses on nozzle 106 spacing, target flow rate for the system, and speed of the agricultural sprayer while ignoring yaw rate, nozzle location on the field, etc. Such examples provide the benefit of simplifying the system to user specifications, provide greater programmability of the system, and providing cost effective nozzle specific flow rate solutions. In yet another example, the ECUs 72 associated with each nozzle 106 are instead consolidated into one or more centralized nodes that determine the individual flow rates of each of the respective nozzles in a similar manner to the previously described ECUs 72 associated with each of the nozzles.

FIG. 7 is an exemplary schematic view of an ECU 80 that acts as part of a smart nozzle 106. The ECU 80 includes two connectors, including a 4-pin thermistor 84 and a 12-pin connector 82-A, and an LED 86. The LED 86, in an example, is indicates the readiness state of the smart nozzle. In an example, the LED 86 is a multi-color LED, wherein a specific color shown along with a rate at which the LED 86 flashes indicates if the smart nozzle is in an error mode, including what type of error, warning state, ready state, actively controlling state, or the like. The 4-pin thermistor 84 includes, in an example, a number of control aspects, such as, but not limited to, valve and thermistor. The 12-pin connector 82-A includes, in an example, a number of control aspects, such as but not limited to any specific configuration, power, ground, nozzle startup, location recognition. Such pin indexing, in an example, is applicable to a smart nozzle or the ISO CAN bus. The lines with arrows signify 88 a cable to daisy-chain ECU 82-A to a 12-pin connector 82-B including pins 83-B, although embodiments are not so limited. The ECU 80 controls the nozzle flow rate based on a number of parameters, including, but not limited to: speed of the sprayer or toolbar, yaw rate, target system flow rate (e.g. volume/area), and on/off command at runtime. Such parameters permits the ECU 80 to calibrate the duty cycle curve (e.g., the duty cycle curve provided by a nozzle manufacturer) of each smart nozzle needed to achieve the target nozzle flow rate of each of the smart nozzles. Each smart nozzle is further configured according to nozzle spacing on the toolbar, location on the toolbar, and nozzle type. Further, each smart nozzle can regulate or control the nozzle flow rate based on the location of the nozzle in the field (as described above).

In an example, the ECU 80 further includes the thermistor 84 so as to provide temperature sensitive control of the nozzle. For example, as power is provided to the thermistor 84, the thermistor 84 heats up, consequently changing the resistivity of the thermistor 84. The agricultural product flows over the thermistor 84, reducing the heat of the thermistor 84 and altering the resistivity of the thermistor 84. In an example, the changes in resistivity of the thermistor 84 are used to indicate or determine that a nozzle is fouled, clogged, or the like. In another example, a pressure sensor or transducer is configured to measure the pressure after each of the PWM valves (e.g., 73, FIG. 5). In an example the pressure transducer is attached to each smart nozzle or plugged as an add-on feature.

In a further example, the overall system data (e.g., actual flow rate compared to targeted flow rate, maintained pressure vs. targeted pressure, etc.) is used to calibrate one or more thermistors. The calibrated thermistor 84 of the smart nozzle is then used to further calibrate the duty cycle curve of the corresponding smart nozzle. Benefits of such examples, provide a more accurate, configurable, and efficient smart nozzle for application of an agricultural product.

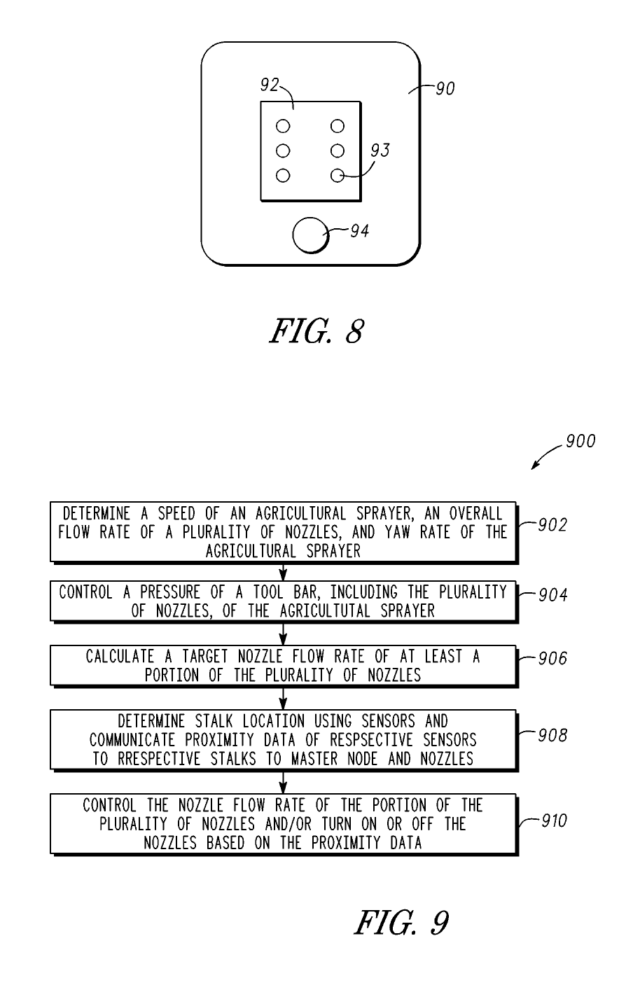

FIG. 8 illustrates an alternative exemplary view of an ECU 90. The ECU 90 includes a 6-pin 93 connector 92 and an LED 94 on the circuit board. In such an example, each ECU 90 is wired to one another or wired to a centrally located hub. Although some nozzle control systems and methods described herein reference a PWM master valve communicatively coupled to the master node, embodiments are not so limited. For example, other valves are contemplated. Further, examples herein are described in relation to an agricultural sprayer, but other embodiments, such as, but not limited to, planters or toolbars, are contemplated.

FIG. 9 is a block diagram showing one example of a method 900 for controlling nozzle flow rate on an agricultural sprayer having a toolbar with a plurality of nozzles. In describing the method 900, reference is made to features and elements previously described herein, although not numbered. At 902, the method 100 includes determining a speed of an agricultural sprayer, an overall flow rate of a plurality of nozzles, and yaw rate of the agricultural sprayer. In an example, the speed of the agricultural sprayer is determined by a GPS module, an accelerometer, a speedometer, tachometer, or the like. In an example, the overall flow rate of the plurality of nozzles is determined by a sum of the individual flow rates of each of the plurality of nozzles or is measured by a flow meter. In an example, the yaw rate is determined by a yaw sensor coupled to the toolbar, master node, or agricultural sprayer to detect a yaw of the hull and provide a yaw signal. At 904, a pressure of an agricultural product in a toolbar is controlled by a pressure valve in communication with the master node. At 906, the method 900 includes calculating, using at least one of the speed, the overall flow rate, and the yaw rate, a target nozzle flow rate of at least a portion of the plurality of nozzles. As described herein, at 908 the method includes determining a stalk proximity to nozzles using sensors and communicating proximity data to the master node and nozzles. Finally, the method provides, at 910, controlling the nozzle flow rate of the portion of the plurality of nozzles and/or turning on or off the nozzles based on the proximity data.

In an example, the method includes determining a toolbar section flow rate, including a portion of the plurality of nozzles, based on at least one of the speed, the overall flow rate, and the yaw rate and controlling the flow rate of the toolbar section. For example, the toolbar section corresponds to a nozzle group, as described herein, such as a plurality of nozzles controlled by a common ECU. As described herein, controlling includes controlling each of the nozzles of the plurality of nozzles to dispense the agricultural product at individual rates according to the location the one or more nozzles of the plurality of nozzles on a field map. Further, the current method 900 includes controlling the pressure of the toolbar is independent of controlling the nozzle flow rate of the portion of the plurality of nozzles. Additionally, the method includes turning on or off the nozzles based on the proximity of the stalks to the nozzles, e.g., turning on the nozzles when the nozzles are proximate a respective stalk and turning off the nozzles when the nozzles are currently positioned between stalks.

Another example embodiment will now be described. In this embodiment, the master node handles a number of functions in the system. It communicates with the pump and a pressure sensor in order to regulate pressure in the system to a desired target pressure. It also communicates with a flow sensor to obtain an actual overall flow rate. The master node further receives vehicle speed data from a GPS system, yaw rate from a yaw sensor and a target volume/area of an agriculture product (typically input by a user).

The master node also provides error correction for the system by looping through each smart nozzle and calculating each smart nozzle's flow rate. The master node determines this flow rate based on vehicle speed, yaw rate, the location of the nozzle on the toolbar and the target volume per area. The master node then sums the flow rates and compares this sum to the actual overall system flow rate to determine an error percentage. The error percentage is then provided on the CAN bus for the smart nozzles to change their flow rate.

The master node also checks for saturation points in the flow range for the smart nozzles to make the percent error more accurate. For example, if the master node calculates a flow rate for a smart nozzle that exceeds the nozzle's maximum flow rate, then the master node uses the maximum nozzle flow rate rather than the calculated nozzle flow rate when summing the rates to determine an overall flow rate. The master node in this embodiment does not control the flow rates of the smart nozzles themselves.

Each smart nozzle independently calculates and controls its own flow rate based on CAN bus data from the master node. In an example, each nozzle performs its own flow rate calculation independent from the other nozzles. In particular, the master node transmits vehicle speed, yaw rate, toolbar width, location of each nozzle on the toolbar, target volume per area for the applied product, and the error correction. Using this data provided on the CAN bus, each smart nozzle determines its own flow rate, adjusted for the error correction determined by the master node.

The flow rate for a smart nozzle is obtained by multiplying various inputs together (e.g., speed, yaw rate, volume/area). The system (e.g., the master node) can also apply logic (such as if-then statements) to determine whether a smart nozzle should be on or off. For example, if there is an error or the master switch is off, the target rate may not be applied to the smart nozzle and the smart nozzle may be shut off. Alternatively, if the master node receives input from the sensors that the nozzles are currently positioned in an area that is distal from a respective plant, the smart nozzle may be shut off.

### Various Notes & Examples

Example 1 can include subject matter such as an agricultural product delivery apparatus, comprising: a toolbar including a plurality of legs extending from the toolbar; an agricultural product delivery nozzle coupled to at least one of the plurality of legs, the agricultural product delivery nozzle configured to deliver an agricultural product proximate to a plant; a sensor coupled to the toolbar, wherein the sensor is configured to detect a plant characteristic of the plant while the plant is ahead of the agricultural product delivery nozzle; and a controller configured to associate the plant with an agricultural product characteristic based on the plant characteristic, the controller configured to operate the delivery nozzle to deliver the agricultural product proximate to the plant.

Example 2 can include, or can optionally be combined with the subject matter of Example 1, to optionally include wherein the sensor is a contact type sensor.

Example 3 can include, or can optionally be combined with the subject matter of one or any combination of Examples 1 or 2, to optionally include wherein the sensor is at least one of a whisker sensor, a load cell, a force impact sensor, and a pressure sensor.

Example 4 can include, or can optionally be combined with the subject matter of one or any combination of Examples 1-3, to optionally include wherein the sensor is a non-contact type sensor.

Example 5 can include, or can optionally be combined with the subject matter of one or any combination of Examples 1-4, to optionally include wherein the sensor is at least one of an optical sensor, a video sensor network, a single stream video, and an infrared sensor.

Example 6 can include, or can optionally be combined with the subject matter of one or any combination of Examples 1-5, to optionally include wherein the plant is positioned a known distance from the agricultural product delivery nozzle.

Example 7 can include, or can optionally be combined with the subject matter of one or any combination of Examples 1-6, to optionally include wherein the toolbar is a pull type toolbar.

Example 8 can include, or can optionally be combined with the subject matter of one or any combination of Examples 1-7, to optionally include wherein the toolbar is a push type toolbar.

Example 9 can include, or can optionally be combined with the subject matter of one or any combination of Examples 1-8, to optionally include wherein plant characteristic includes at least one of a corn stalk location, a type of corn, dimensions of the plant, and a normalized difference vegetation index factor.

Example 10 can include, or can optionally be combined with the subject matter of one or any combination of Examples 1-9, to optionally include wherein the agricultural product characteristic includes at least one of a type of agricultural product, a concentration of agricultural product, a delivery rate of agricultural product, a delivery time of agricultural product, and an amount of agricultural product.

Example 11 can include, or can optionally be combined with the subject matter of one or any combination of Examples 1-10, to optionally include wherein the sensor is a normalized difference vegetation index (NDVI) sensor.

Example 12 can include subject matter such as an agricultural product delivery system, comprising: a vehicle configured to move in a direction; a high clearance toolbar coupled to the vehicle, the high clearance toolbar including a cross bar and a plurality of legs extending from the cross bar; at least one agricultural product delivery nozzle coupled to one of the plurality of legs, the at least one agricultural product delivery nozzle is configured to deliver an agricultural product proximate a plant; one or more sensors coupled to at least one of the crossbar and the plurality of legs, wherein the one or more sensors are configured to detect a plant characteristic of the plant when the vehicle is moving in the direction, when the plant is located in the direction relative to the agricultural product delivery nozzle; and a controller configured to associate the plant with an agricultural product characteristic based on the plant characteristic, the controller configured to operate the delivery nozzle to deliver the agricultural product proximate to the plant

Example 13 can include, or can optionally be combined with the subject matter of Example 12, to optionally include wherein the one or more sensors are at least one of a whisker sensor, a load cell, a force impact sensor, and a pressure sensor.

Example 14 can include, or can optionally be combined with the subject matter of one or any combination of Examples 12-13, to optionally include wherein the one or more sensors are at least one of an optical sensor, a video sensor network, a single stream video, and an infrared sensor.

Example 15 can include, or can optionally be combined with the subject matter of one or any combination of Examples 12-14, to optionally include wherein at least one of the one or more legs includes a fertilizer delivery nozzle configured to deliver fertilizer proximate a base of the plant.

Example 16 can include, or can optionally be combined with the subject matter of one or any combination of Examples 12-15, to optionally include wherein the toolbar is positioned in front of the vehicle or in back of the vehicle.

Example 17 can include, or can optionally be combined with the subject matter of one or any combination of Examples 12-16, to optionally include wherein plant characteristic includes at least one of a plant location, a type of corn, dimensions of the plant, and a normalized difference vegetation index factor.

Example 18 can include, or can optionally be combined with the subject matter of one or any combination of Examples 12-17, to optionally include wherein the agricultural product characteristic includes at least one of a type of agricultural product, a concentration of agricultural product, a delivery rate of agricultural product, a delivery time of agricultural product, and an amount of agricultural product.

Example 19 can include, or can optionally be combined with the subject matter of one or any combination of Examples 12-18, to optionally include wherein the sensor is a normalized difference vegetation index (NDVI) sensor.

Example 20 can include subject matter such as a method for delivering an agricultural product, comprising: moving a vehicle in a direction, the vehicle including a high clearance toolbar coupled to the vehicle, wherein the toolbar includes a plurality of legs coupled with the toolbar, at least one of the plurality of legs including at least one agricultural product delivery nozzle configured to deliver an agricultural product; detecting at least one plant characteristic of a plant with one or more sensors coupled to the toolbar and directed in the direction relative to the plurality of legs, when the plant is in the direction ahead of the at least one agricultural product delivery nozzle; associating an agricultural product characteristic to the plant based on the detected at least one plant characteristic of the plant; and delivering the agricultural product to the detected plant with the at least one agricultural product delivery nozzle while the plant is proximate the agricultural product delivery nozzle, the delivered agricultural product based on the associated agricultural product characteristic.

Example 21 can include, or can optionally be combined with the subject matter of Example 20, to optionally include detecting the plant with a contact sensor of the one or more sensors.

Example 22 can include, or can optionally be combined with the subject matter of one or any combination of Examples 20-21, to optionally include detecting the plant with a non-contact sensor of the one or more sensors.

Example 23 can include, or can optionally be combined with the subject matter of one or any combination of Examples 20-22, to optionally include wherein the at least one plant characteristic includes at least one of a corn stalk location, a type of corn, dimensions of the corn stalk, and a normalized difference vegetation index factor.

Example 24 can include, or can optionally be combined with the subject matter of one or any combination of Examples 20-23, to optionally include wherein the agricultural product characteristic includes at least one of a type of agricultural product, a concentration of agricultural product, a delivery rate of agricultural product, a delivery time of agricultural product, and an amount of agricultural product.

Example 25 can include, or can optionally be combined with the subject matter of one or any combination of Examples 20-24, to optionally include determining the delivery time of agricultural product based on at least one of distance of the one or more sensor relative to the toolbar and a speed of the vehicle in the direction.

Example 26 can include subject matter such as an agricultural product delivery apparatus, comprising: at least one agricultural product storage tank including at least one agricultural product; a toolbar including at least one agricultural product delivery nozzle coupled to the toolbar and configured to deliver the at least one agricultural product proximate a plant; a sensor coupled to the toolbar, wherein the sensor is configured to detect a plant characteristic of the plant when the plant is ahead of the at least one agricultural product delivery nozzle; and a controller configured to associate an agricultural product characteristic with the plant based on the plant characteristic, so as to operate the at least one agricultural product delivery nozzle to deliver the agricultural product proximate to the plant.

Example 27 can include, or can optionally be combined with the subject matter of Example 26, to optionally include wherein plant characteristic includes at least one of a corn stalk location, a type of corn, dimensions of the corn stalk, and a normalized difference vegetation index factor.

Example 28 can include, or can optionally be combined with the subject matter of one or any combination of Examples 26-27, to optionally include wherein the agricultural product characteristic includes at least one of a type of agricultural product, a concentration of agricultural product, a delivery rate of agricultural product, a delivery time of agricultural product, and an amount of agricultural product.

Example 29 can include, or can optionally be combined with the subject matter of one or any combination of Examples 26-28, to optionally include wherein the tool bar is at least one of a pull-type toolbar and a push-type toolbar.

Example 30 can include, or can optionally be combined with the subject matter of one or any combination of Examples 26-29, to optionally include wherein the sensor is at least one of a whisker sensor, a load cell, a force impact sensor, and a pressure sensor.

Example 31 can include, or can optionally be combined with the subject matter of one or any combination of Examples 26-30, to optionally include wherein the sensor is at least one of an optical sensor, a video sensor network, a single stream video, a normalized differential vegetation index (NDVI) sensor, and an infrared sensor.

Example 32 can include subject matter such as an agricultural product delivery system, comprising: a vehicle configured to move in a direction, the vehicle including an agricultural product storage tank including an agricultural product; a toolbar coupled to the vehicle; at least one agricultural product delivery nozzles coupled to the toolbar, the at least one agricultural product delivery nozzle configured to deliver the agricultural product proximate a plant; one or more sensors coupled to the toolbar and directed in the direction relative to the at least one agricultural product delivery nozzle, wherein the one or more sensors is configured to detect a plant characteristic of the plant forward of the one or more sensors; and a controller configured to associate an agricultural product characteristic with the plant based on the plant characteristic, the controller configured to operate the at least one agricultural product delivery nozzle to deliver the agricultural product proximate to the plant.

Example 33 can include, or can optionally be combined with the subject matter of Example 32, to optionally include wherein the sensor is at least one of a whisker sensor, a load cell, a force impact sensor, and a pressure sensor.

Example 34 can include, or can optionally be combined with the subject matter of one or any combination of Examples 32-33, to optionally include wherein the sensor is at least one of an optical sensor, a video sensor network, a single stream video, and an infrared sensor.

Example 35 can include, or can optionally be combined with the subject matter of one or any combination of Examples 32-34, to optionally include wherein the at least one plant characteristic includes at least one of a corn stalk location, a type of corn, dimensions of the corn stalk, and a normalized difference vegetation index factor.

Example 36 can include, or can optionally be combined with the subject matter of one or any combination of Examples 32-35, to optionally include wherein the agricultural product characteristic includes at least one of a type of agricultural product, a concentration of agricultural product, a delivery rate of agricultural product, a delivery time of agricultural product, and an amount of agricultural product.

Example 37 can include, or can optionally be combined with the subject matter of one or any combination of Examples 32-36, to optionally include wherein the sensor is a normalized difference vegetation index (NDVI) sensor.

Example 38 can include the subject matter, including the apparatus, system, and method, of one or any combination of Examples 1-37.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An agricultural product delivery apparatus, comprising:
a toolbar including a plurality of legs extending from the toolbar;
an agricultural product delivery nozzle coupled to at least one of the plurality of legs, the agricultural product delivery nozzle configured to deliver an agricultural product proximate to a plant;
a sensor coupled to the toolbar, wherein the sensor is configured to detect a plant characteristic of the plant while the plant is ahead of the agricultural product delivery nozzle; and
a controller configured to associate the plant with an agricultural product characteristic based on the plant characteristic, the controller configured to operate the delivery nozzle to deliver the agricultural product proximate to the plant.

2. The apparatus of claim 1, wherein the sensor is a contact type sensor.

3. The apparatus of claim 2, wherein the sensor is at least one of a whisker sensor, a load cell, a force impact sensor, and a pressure sensor.

4. The apparatus of claim 1, wherein the sensor is a non-contact type sensor.

5. The apparatus of claim 4, wherein the sensor is at least one of an optical sensor, a video sensor network, a single stream video, and an infrared sensor.

6. The apparatus of claim 1, wherein the plant is positioned a known distance from the agricultural product delivery nozzle.

7. The apparatus of claim 1, wherein the toolbar is a pull type toolbar.

8. The apparatus of claim 1, wherein the toolbar is a push type toolbar.

9. The apparatus of claim 1, wherein plant characteristic includes at least one of a corn stalk location, a type of corn, dimensions of the corn stalk, and a normalized difference vegetation index factor.

10. The apparatus of claim 1, wherein the agricultural product characteristic includes at least one of a type of agricultural product, a concentration of agricultural product, a delivery rate of agricultural product, a delivery time of agricultural product, and an amount of agricultural product.

11. The apparatus of claim 1, wherein the sensor is a normalized difference vegetation index (NDVI) sensor.

12. An agricultural product delivery system, comprising:
a vehicle configured to move in a direction;
a high clearance toolbar coupled to the vehicle, the high clearance toolbar including a cross bar and a plurality of legs extending from the cross bar;
at least one agricultural product delivery nozzle coupled to one of the plurality of legs, the at least one agricultural product delivery nozzle is configured to deliver an agricultural product proximate a plant;
one or more sensors coupled to at least one of the crossbar and the plurality of legs, wherein the one or more sensors are configured to detect a plant characteristic of the plant when the vehicle is moving in the direction, when the plant is located in the direction relative to the agricultural product delivery nozzle; and
a controller configured to associate the plant with an agricultural product characteristic based on the plant characteristic, the controller configured to operate the delivery nozzle to deliver the agricultural product proximate to the plant.

13. The system of claim 12, wherein the one or more sensors are at least one of a whisker sensor, a load cell, a force impact sensor, and a pressure sensor.

14. The system of claim 12, wherein the one or more sensors are at least one of an optical sensor, a video sensor network, a single stream video, and an infrared sensor.

15. The system of claim 12, wherein at least one of the one or more legs includes a fertilizer delivery nozzle configured to deliver fertilizer proximate a base of the plant.

16. The system of claim 12, wherein the toolbar is positioned in front of the vehicle or in back of the vehicle.

17. The system of claim 12, wherein plant characteristic includes at least one of a corn stalk location, a type of corn, dimensions of the corn stalk, and a normalized difference vegetation index factor.

18. The system of claim 12, wherein the agricultural product characteristic includes at least one of a type of agricultural product, a concentration of agricultural product, a delivery rate of agricultural product, a delivery time of agricultural product, and an amount of agricultural product.

19. The system of claim 12, wherein the sensor is a normalized difference vegetation index (NDVI) sensor.

20. A method for delivering an agricultural product, comprising:
moving a vehicle in a direction, the vehicle including a high clearance toolbar coupled to the vehicle, wherein the toolbar includes a plurality of legs coupled with the toolbar, at least one of the plurality of legs including at least one agricultural product delivery nozzle configured to deliver an agricultural product;
detecting at least one plant characteristic of a plant with one or more sensors coupled to the toolbar and directed in the direction relative to the plurality of legs, when the plant is in the direction ahead of the at least one agricultural product delivery nozzle;
associating an agricultural product characteristic to the plant based on the detected at least one plant characteristic of the plant; and
delivering the agricultural product to the detected plant with the at least one agricultural product delivery nozzle while the plant is proximate the agricultural product delivery nozzle, the delivered agricultural product based on the associated agricultural product characteristic.

21. The method of claim 20, further comprising detecting the plant with a contact sensor of the one or more sensors.

22. The method of claim 20, further comprising detecting the plant with a non-contact sensor of the one or more sensors.

23. The method of claim 20, wherein the at least one plant characteristic includes at least one of a corn stalk location, a type of corn, dimensions of the corn stalk, and a normalized difference vegetation index factor.

24. The method of claim 20, wherein the agricultural product characteristic includes at least one of a type of agricultural product, a concentration of agricultural product, a delivery rate of agricultural product, a delivery time of agricultural product, and an amount of agricultural product.

25. The method of claim 24, further comprising determining the delivery time of agricultural product based on at least one of distance of the one or more sensor relative to the toolbar and a speed of the vehicle in the direction.

26. An agricultural product delivery apparatus, comprising:
at least one agricultural product storage tank including at least one agricultural product;
a toolbar including at least one agricultural product delivery nozzle coupled to the toolbar and configured to deliver the at least one agricultural product proximate a plant;
a sensor coupled to the toolbar, wherein the sensor is configured to detect a plant characteristic of the plant when the plant is ahead of the at least one agricultural product delivery nozzle; and
a controller configured to associate an agricultural product characteristic with the plant based on the plant characteristic, so as to operate the at least one agricultural product delivery nozzle to deliver the agricultural product proximate to the plant.

27. The apparatus of claim 26, wherein plant characteristic includes at least one of a corn stalk location, a type of corn, dimensions of the corn stalk, and a normalized difference vegetation index factor.

28. The apparatus of claim 26, wherein the agricultural product characteristic includes at least one of a type of agricultural product, a concentration of agricultural product, a delivery rate of agricultural product, a delivery time of agricultural product, and an amount of agricultural product.

29. The apparatus of claim 26, wherein the tool bar is at least one of a pull-type toolbar and a push-type toolbar.

30. The apparatus of claim 26, wherein the sensor is at least one of a whisker sensor, a load cell, a force impact sensor, and a pressure sensor.

31. The apparatus of claim 26, wherein the sensor is at least one of an optical sensor, a video sensor network, a single stream video, a normalized differential vegetation index (NDVI) sensor, and an infrared sensor.

32. An agricultural product delivery system, comprising:
a vehicle configured to move in a direction, the vehicle including an agricultural product storage tank including an agricultural product;
a toolbar coupled to the vehicle;
at least one agricultural product delivery nozzles coupled to the toolbar, the at least one agricultural product delivery nozzle configured to deliver the agricultural product proximate a plant;
one or more sensors coupled to the toolbar and directed in the direction relative to the at least one agricultural product delivery nozzle, wherein the one or more sensors is configured to detect a plant characteristic of the plant forward of the one or more sensors; and
a controller configured to associate an agricultural product characteristic with the plant based on the plant characteristic, the controller configured to operate the at least one agricultural product delivery nozzle to deliver the agricultural product proximate to the plant.

33. The apparatus of claim 32, wherein the sensor is at least one of a whisker sensor, a load cell, a force impact sensor, and a pressure sensor.

34. The apparatus of claim 32, wherein the sensor is at least one of an optical sensor, a video sensor network, a single stream video, and an infrared sensor.

35. The method of claim 32, wherein the at least one plant characteristic includes at least one of a corn stalk location, a type of corn, dimensions of the corn stalk, and a normalized difference vegetation index factor.

36. The method of claim 32, wherein the agricultural product characteristic includes at least one of a type of agricultural product, a concentration of agricultural product, a delivery rate of agricultural product, a delivery time of agricultural product, and an amount of agricultural product.

37. The apparatus of claim 32, wherein the sensor is a normalized difference vegetation index (NDVI) sensor.
